(19) United States
(12) Patent Application Publication
(10) Pub. No.: US 2026/0004671 A1
(43) Pub. Date: Jan. 1, 2026

(54) SYSTEMS AND METHODS FOR ASSISTING A USER IN ASSEMBLING A FURNITURE MODULE

(71) Applicant: Magick Woods Exports Private Limited, Maraimalai Nagar (IN)

(72) Inventor: Indrakumar PATHMANATHAN, Thornhill (CA)

(73) Assignee: Magick Woods Exports Private Limited, Maraimalai Nagar (IN)

(21) Appl. No.: 19/224,975

(22) Filed: Jun. 2, 2025

(30) Foreign Application Priority Data
Jun. 28, 2024 (IN) 202441049810

(51) Int. Cl. G09B 5/06; G06K 7/14; G06K 19/06

(52) U.S. Cl. CPC G09B 5/065; G06K 7/1413; G06K 7/1417; G06K 19/06028; G06K 19/06037

(57) ABSTRACT

A method for assisting a user to assemble one or more furniture modules in a room includes the steps of receiving one or more identification codes corresponding to the one or more furniture modules and identifying a furniture type for each of the one or more furniture modules based on the one or more identification codes. Further, the method includes the steps of obtaining a layout of the one or more furniture modules based on the one or more identification codes and the furniture type, wherein the one or more furniture modules are arranged in a predefined pattern in the layout, allowing the user to select a first furniture module from the layout displayed to the user on a display, and displaying a first assembling and installation video corresponding to the first furniture module selected by the user and the layout. A system in configured to implement the method.

### RELATED APPLICATION(S)

This application claims the benefit of priority of India Patent Application No. 202441049810 filed on Jun. 28, 2024, the contents of which are all incorporated by reference as if fully set forth herein in their entirety.

### FIELD AND BACKGROUND OF THE INVENTION

The present disclosure relates to the field of furniture systems. More specifically, the present disclosure relates to a virtual interactive furniture assembly systems and method to assemble furniture components.

Ready-to-assemble (RTA) furniture or Ready-to-install (RTI) furniture requires a customer of the future to perform assembly and/or installation at the installation site. The RTA furniture, also known as knock-down furniture (KD), flat-pack furniture, or kit furniture, is a form of furniture that is shipped with dismantled pieces packed in cartons with assembly instructions.

### SUMMARY OF THE INVENTION

Currently, the RTA and RTI furniture kits have been expanded to include the entire layout of a room. For example, a kitchen may be built in modules rather than built as a whole. Each module may be configured as a kit which involves installation and assembly of a set of standardized parts or independent units of entire spaces.

Typically, assembly of a furniture is time-consuming and cumbersome due to lack of sufficient or clear assembly instructions or complexity of the instructions. Conventionally, the assembly instructions are provided as an electronic document or as a physically printed document with text and/or images. However, despite such instructions in the electronic/physical document format, a customer may find it difficult to assemble the furniture since documented instructions would not be able to guide the customer on various nuances involved during the assembly. Further, the limited number of static pictures or graphical representations contained in typical manuals falls far short of the degree of visualization required to effectively present instructional materials in many areas of assembly and installation. Oftentimes, the user may also be confused regarding the steps involved and/or steps to be taken to fix errors if any at any given point of time during the assembly. Moreover, the user may even struggle to identify the components required for assembly among the different components provided.

### BRIEF DESCRIPTION OF THE SEVERAL VIEWS OF THE DRAWING(S)

FIG. 1 is a schematic block diagram of a computing device for assisting a user in assembling furniture modules, in accordance with an embodiment of the present disclosure;

FIG. 2 is a schematic block diagram of a server for assisting a user in assembling the furniture modules, the server is in communication with the device of FIG. 1, in accordance with an embodiment of the present disclosure;

FIG. 3 is an exemplary illustration of a view of packaged boxes with furniture components delivered to the user, in accordance with the embodiment of the present disclosure;

FIG. 4 is an exemplary illustration of a kitchen layout displayed to the user by the computing device of FIG. 1, in accordance with an embodiment of the present disclosure;

FIG. 5 is an exemplary illustration of arrangement of furniture modules within the kitchen layout of FIG. 4, in accordance with the embodiment of the present disclosure;

FIG. 6 is an exemplary illustration of different states installing the furniture modules with assistance of the computing device of FIG. 1, in accordance with the embodiment of the present disclosure;

FIG. 7 is an exemplary illustration of displaying information of the furniture modules by the computing device of FIG. 1, in accordance with the embodiment of the present disclosure;

FIG. 8A and FIG. 8B are an exemplary illustration of displaying details about the components of wall cabinets by the computing device of FIG. 1, in accordance with the embodiment of the present disclosure;

FIG. 9 and FIG. 10 are exemplary illustrations of an intermediate step and a last step of assembling and installing a wall cabinet module of FIG. 8A, in accordance with the embodiment of the present disclosure;

FIG. 11A to FIG. 11H are exemplary illustrations of step-by-step guide to assemble and install a wall cabinet module of FIG. 8B, in accordance with the embodiment of the present disclosure;

FIG. 12 is an exemplary method for assisting the user to assemble one or more furniture modules in the room, implemented by the computing device of FIG. 1, in accordance with the embodiment of the present disclosure; and

FIG. 13 is an exemplary method for assisting the user to assemble one or more furniture modules in the room, implemented by the server of FIG. 2.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various embodiments of the present disclosure.

### DESCRIPTION OF SPECIFIC EMBODIMENTS OF THE INVENTION

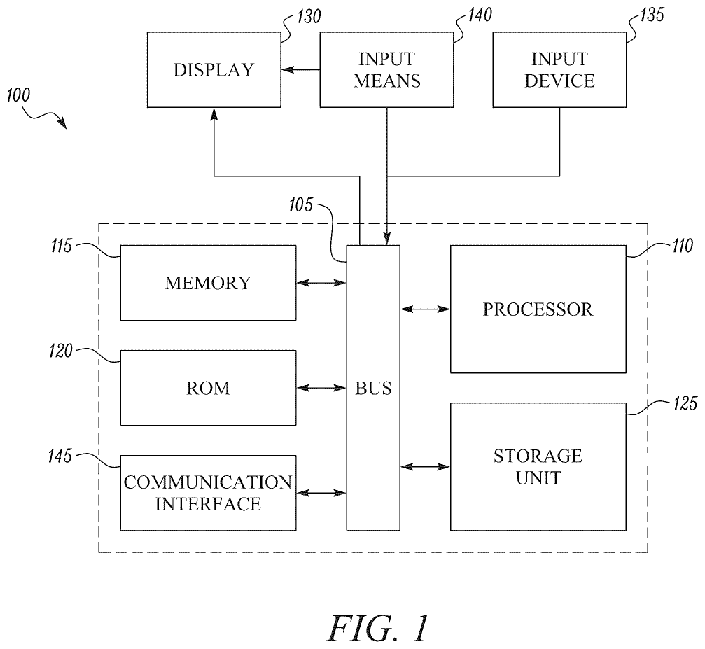

FIG. 1 is a schematic block diagram of a computing device 100, herein after referred to as a device, for assisting a user in assembling one or more furniture modules, in accordance with an embodiment of the present disclosure. Examples of the computing device 100 may include, but are not limited to, computers, laptops, mobile devices, handheld devices, personal digital assistants (PDAs), tablet personal computers, digital notebook, and similar electronic devices.

The computing device 100 includes a bus 105 or other communication mechanism for communicating information, and a processor coupled with the bus 105 for processing information. The computing device 100 also includes a memory 115, such as a random-access memory (RAM) or other dynamic storage device, coupled to the bus 105 for storing information and instructions to be executed by the processor 110. The memory 115 can be used for storing temporary variables or other intermediate information during execution of instructions to be executed by the processor 110. The computing device 100 further includes a read only memory (ROM) 120 or other static storage device coupled to bus 105 for storing static information and instructions for processor 110. A storage unit 125, for example, but not limited to, a magnetic disk or optical disk or solid-state drive (SSD), is provided and coupled to the bus 105. The storage unit 125 may store data retrieved from different data sources, one or more machine-learning models, or a server. The machine-learning models correspond to mathematical models and configured to generate a layout for a room based on information received about furniture modules. The information may include, but not limited to, model name, type of furniture, dimensions of the furniture, user preferences, and room structure.

The computing device 110 can be coupled via the bus 105 to a display 130 for displaying information to the user. The display may be based on technologies such as cathode ray tube (CRT), liquid crystal display (LCD) technology, Light Emitting Diode (LED), Organic LED (OLED), Active-matrix OLED (AMOLED), etc. An input device 135, including alphanumeric and other keys, is coupled to bus 105 for communicating information and command selections to the processor 110. Another type of user input device is a cursor control 140, such as a mouse, a trackball, or cursor direction keys for communicating direction information and command selections to the processor 110 and for controlling cursor movement on the display 130. The input device 135 can also be included in the display 130, for example a touch screen and may also include compatible devices with the display 130 such as a stylus. Further, the input device 135 can also include audio-visual devices such as a microphone or a camera.

Various embodiments are related to the use of computing device 100 for implementing the techniques described herein. In one embodiment, the techniques are performed by the computing device 100 in response to the processor 110 executing instructions included in the memory 115. Such instructions can be read into the memory 115 from another machine-readable medium, such as the storage unit 125. Execution of the instructions included in the memory 115 causes the processor 110 to perform the process steps described herein.

The term “machine-readable medium” as used herein refers to any medium that participates in providing data that causes a machine to operate in a specific fashion. In an embodiment implemented using the computing device 100, various machine-readable medium is involved, for example, in providing instructions to the processor 110 for execution. The machine-readable medium can be a storage media. Storage media includes both non-volatile media and volatile media. Non-volatile media includes, for example, optical or magnetic disks or sloid state drive, such as storage unit 125. Volatile media includes dynamic memory, such as the memory 115. All such media must be tangible to enable the instructions carried by the media to be detected by a physical mechanism that reads the instructions into a machine.

Common forms of machine-readable medium include, for example, a floppy disk, a flexible disk, hard disk, magnetic tape, or any other magnetic medium, a CD-ROM, any other optical medium, punch cards, paper-tape, any other physical medium with patterns of holes, a RAM, a PROM, and EPROM, a FLASH-EPROM, any other memory chip or cartridge.

In another embodiment, the machine-readable medium can be a transmission media including coaxial cables, copper wire and fiber optics, including the wires that comprise the bus 105. Transmission media can also take the form of acoustic or light waves, such as those generated during radio-wave and infra-red data communications. Examples of machine-readable medium may include but are not limited to a carrier wave as describer hereinafter or any other medium from which the computing device 100 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the computing device 100 can receive the data on the telephone line and use an infra-red transmitter to convert the data to an infra-red signal. An infra-red detector can receive the data carried in the infra-red signal and appropriate circuitry can place the data on the bus 105. The bus 105 carries the data to the memory 115, from which the processor 110 retrieves and executes the instructions. The instructions received by the memory 115 can optionally be stored on storage unit 125 either before or after execution by the processor 110. All such media must be tangible to enable the instructions carried by the media to be detected by a physical mechanism that reads the instructions into a machine.

The computing device 100 also includes a communication interface 145 coupled to the bus 105. The communication interface 145 provides a two-way data communication coupling to a network. For example, the communication interface 145 can be an integrated service digital network (ISDN) card or a modem to provide a data communication connection to a corresponding type of telephone line. As another example, the communication interface 145 can be a local area network (LAN) card to provide a data communication connection to a compatible LAN. Wireless links can also be implemented. In any such implementation, the communication interface 145 sends and receives electrical, electromagnetic or optical signals that carry digital data streams representing various types of information.

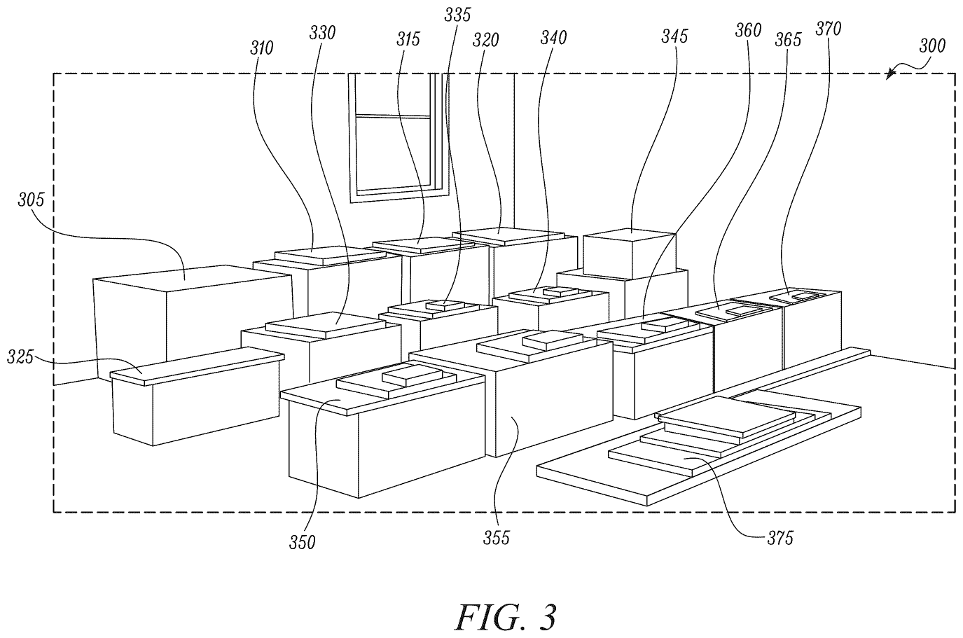

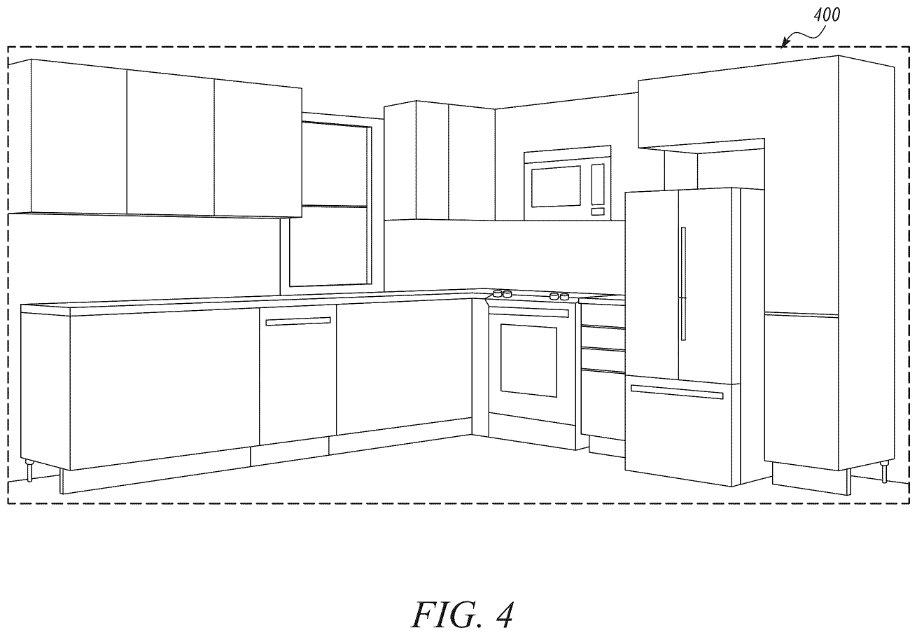

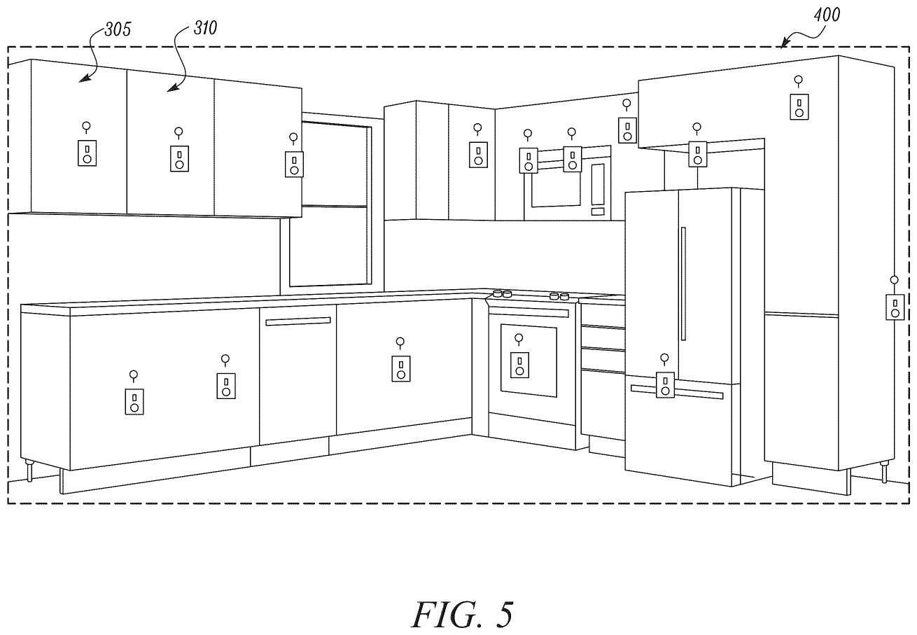

In some embodiments, the processor 110 may be capable of executing the one or more predefined computer instructions in order to perform one or more functions. The processor 110 is configured to receive one or more identification codes corresponding to the one or more furniture modules 305-375 (as shown in FIG. 3), identify a furniture type for each of the one or more furniture modules based on the one or more identification codes, obtain a layout for the one or more furniture modules 305-375 based on at least one of the identification codes corresponding to the one or more furniture module 305-375, the furniture type, or the room structure and dimensions. In an example implementation, the room may be a kitchen. Therefore, the processor 100 obtains a kitchen layout 400 (as shown in FIG. 4). The one or more furniture modules 305-375 may be arranged in a predefined pattern within the kitchen layout 400 (as shown in FIG. 5) Further, the processor 110 displays the kitchen layout 400 to the user on the display 130, receives a first input, from the user through the input device 135, for selection of a first furniture module from the kitchen layout 400, and obtains a first visual instructions corresponding to a first identification code associated with the first furniture module selected by the user and the kitchen layout 400. The first video includes a step-by-step process for the assembling and installation of the first furniture module.

Further, the processor 110 is configured to receive a second input from the user through the input device 135, for selection of a second furniture module of the one or more furniture module 305-375. The processor 100 obtains and displays a second video based on a second identification code associated with the second furniture module selected by the user and the kitchen layout 400. The first video and the second video include step-by-step processes for the assembling and installation of the first furniture module and the second furniture module, respectively.

In some embodiments, the process of displaying the first visual instructions or the second visual instructions by the processor 110 may include displaying information about the selected furniture module and a hyperlink to access the visual instructions. When the user clicks the hyperlink, a video for assembling and installing the selected furniture module may be displayed to the user.

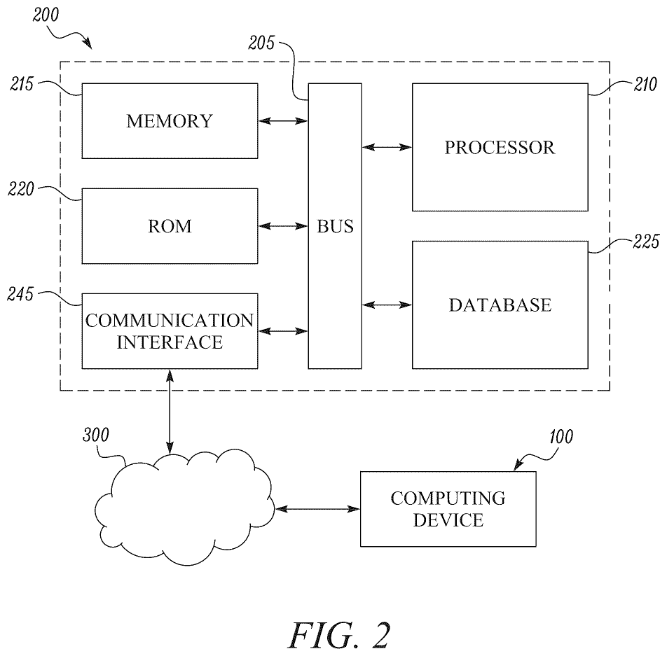

In some embodiments, the process of obtaining the layout 400 of the one or more furniture modules 305-375 by the processor 110 may include generating the kitchen layout 400 by the processor 110 using the machine learned model(s) or receiving the kitchen layout 400 from a server 200 (as shown in FIG. 2). The processor 110 may obtain a modified layout when a third input from the user is received for re-arrangement of the one or more furniture modules 305-375 within the kitchen layout 400. The processor 110 may allow the user to modify the layout 400 by providing option(s) to move or readjust a location of a furniture module within the layout 400. Based on the third input from the user, the processor 110 may generate the modified layout using the machine learning model(s) or may receive the modified layout from the server 200 (as shown in FIG. 2). Thereafter, the processor 110 may display the modified layout on the display 130. Accordingly, in one embodiment, the computing device 100 is configured to generate the kitchen layout 400 and the modified layout. In another embodiment, the computing device 100 is configured to obtain the layout 400 and the modified layout from the server 200 and the server is configured to generate the kitchen layout 400 and the modified layout.

In some example implementations, the one or more furniture modules 305-375 are arranged within the kitchen layout 400 according to at least one of predefined rules, user preferences, and room structure/dimensions. The dimensions may include length, width, and height of the room and the room structure may include all the walls, window(s), entry/exit locations, and position of water supply, drainage, gas supply within the room. Any further modification of the kitchen layout 400 based on the user's input may be based on the predefined rules. The predefined rules may be legal requirements, regulations, statutory rules, advisories, or best practices being followed in the jurisdiction of residence of the user. The processor 110 may indicate to the user whether the modification request of the kitchen layout 400 would be allowable as per the predefined rules.

In some example implementations, the one or more identification codes may be provided as one of barcode and quick-response (QR) code. The identification codes for the furniture modules 305-375 may be printed as barcode or QR code on the packages of the furniture modules purchased by the user. FIG. 3 illustrates a view 300 of packaged boxes of the furniture modules 305-375 delivered to the user, in accordance with an embodiment of the present disclosure. The packaged boxes may have identification codes printed on the surfaces in inform of QR codes or barcodes.

The processor 110 may allow the user to scan the codes provided on the packaged boxes through the camera of the computing device 100 to capture all the barcodes codes or the QR codes from the packages of the furniture modules 305-375. The processor 110 obtains the identification codes for each of the furniture modules 305-375 by decoding the barcodes or the QR codes. Thereafter, the processor 110 utilizes the identification codes to obtain information of the furniture modules 305-375, which may include model name, dimensions, type of furniture, stock keeping unit (SKU) number, quantity, description, etc. For example, the processor 110 may determines ten identification codes. The processor 110 may further determine that five furniture modules are cabinets with shelves, two furniture modules are drawer assemblies, and the remaining three cabinets are wall hanging assemblies of different dimensions. Accordingly, the processor 110 may either implement the machine learning modules to generate the kitchen layout 400 based on the dimensions of the room, the information of the furniture modules 305-375, the predefined rules, or the user preferences or may obtain the layout 400 from the server 200.

FIG. 2 is a schematic block diagram of the server 200 for assisting a user in assembling one or more furniture modules, in accordance with an embodiment of the present disclosure. The server 200 is in communication with the computing device 100 of FIG. 1 over a network 300. The network 300 may include communication networks such as, but not limited to, a Local Area Network (LAN), a Wireless Local Area Network (WLAN), a Wide Area Network (WAN), internet, a Small Area Network (SAN), and the Internet.

The server 200 may be a computing system or a group of computing systems configured to provide services, data, program, or resources, over the network 300. Referring to FIG. 2, the server 200 includes a bus 205 or other communication mechanism for communicating information, a processor unit 210 coupled with the bus 205 for processing information, and a memory 215 coupled to the bus 205 for storing information and instructions to be executed by the processor unit 210. Further, the server 200 further a read only memory (ROM) 220 or other static storage device coupled to the bus 205 for storing static information and instructions for processing unit 210. The processing unit 210 may include a processor or an array of processors working in parallel and sharing server components like computer clock, the bus 205, the memory 215, ROM 220, etc. In some embodiments, the bus 205, the processing unit 210, the memory 215, and the ROM 220 may be configured to operate according to the description provided for the bus 105, the processor 110, the memory 115, and the ROM 120 of the computing device 100, respectively.

Further, a database 225 is provided with the server 200 and coupled to the bus 105. The database 225 may store detailed information about the furniture modules, the processing unit 210 may retrieve information about the furniture modules based on the identification codes. The detailed information may include model name, dimensions, color of the furniture module, name, type of furniture module, SKU number, list of parts and/or components, or an identification code associated with the selected furniture module. Examples for types of furniture module may include, but not limited to, cabinet, shelves, drawers, organizes, worktops, trolleys, or accessories. Further, the detailed information may include visual instruction manuals for assembling and installing the furniture module. The visual instruction manuals may be an audio and/or a video tutorial(s) providing a step-by-step guidance to view and assemble multiple components of the furniture module. The visual instruction may be in two-dimensional (2D) or three-dimensional (3D) imaging. The step-by-step guidance may include unboxing of the furniture module package and positioning all its parts and components in an exploded and packed view. Therefore, the user can visualize and understand how each component of a furniture module is packed. Accordingly, the user may be able to identify and locate components faster. Further, the step-by-step guidance video illustrates each part/component that needs to be assembled/installed. Users may stream through the video on an auto-play mode as well as a manual mode. With the manual mode, the user can go back and forth through the video tutorial. Further, the 3D views of each furniture module and corresponding parts including a zoom feature that may be used throughout the tutorial as and when they need it, unlike a standard video. The processor 110 of the computing device 100 receives inputs from the user though the input device 135 and allows the user to manage and/or control the streaming of the visual instruction manuals displayed on the display 130.

In some embodiments, the database 225 may include identification codes for furniture modules as well as identification codes for part(s) and component(s) of the furniture module. Accordingly, a visual instruction manual for a furniture module stored in the database 225 may be tagged with the identification code of the furniture module and the identification codes of the part(s) and component(s) of the furniture module. Accordingly, the visual instructions manuals in the database 225 may be searchable based on the identification codes of the furniture module or the identification code of corresponding part(s) or component(s).

The server 200 may also include a communication interface 245 coupled to the bus 205. The communication interface 245 provides a two-way data communication coupling to a network. For example, the communication interface 245 can be an integrated service digital network (ISDN) card or a modem to provide a data communication connection to a corresponding type of telephone line. As another example, the communication interface 245 can be a local area network (LAN) card to provide a data communication connection to a compatible LAN. Wireless links can also be implemented. In any such implementation, the communication interface 245 sends and receives electrical, electromagnetic or optical signals that carry digital data streams representing various types of information.

The server 200 may communicate with the computing device 100 according to a client-server architecture. The client-server may implement a request-response communication, i.e., the computing device 100 may send a first request to the server 200 to obtain the layout 400 of the furniture modules or a modified layout of the furniture modules based on the user inputs provided at the communication device 100. The first request may include identification codes obtained by the computing device 100 after decoding the scanned codes, room dimensions, or user preferences. In response to the first request, the processing unit 210 of the server 200 may obtain information about the furniture modules from the database 225 based on the identification codes received in the first request. Thereafter, the processing unit 210 may implement machine learned model(s) to generate the layout 400 for the room and sends the layout 400 to the computing device 100 for displaying to the user. The generated layout 400 confirms to the predefined rules. In some embodiments, the processing unit 210 may send information of the furniture modules present in the layout 400 or may send on an express request from the computing device 100.

The computing device 100 may display the layout 400 (as shown in FIG. 4) on the display 130. In some embodiments, computing device 100 may provide thumbnails 500 corresponding to each of the furniture modules arranged in the layout 400 (as shown in FIG. 5). The thumbnails are expandable windows which provide product details like model name, dimensions, type of furniture, material, price, etc. The thumbnails may also include hyperlink to access audio and/or video instruction manual for assembling and installing the corresponding furniture module.

Further, the computing device 100 may send a second request to the server 200 to obtain information about the selected furniture modules from the layout 400. The second request may be for obtaining product details and for obtaining the audio and/or video instructions for assembling and installing the furniture module. Further, the second request includes an identification code corresponding to the selected furniture module. In response to the second request, the processing unit 210 may retrieve the information about the furniture module from the database 225 and send the retrieved information to the computing device 100. In some embodiments, the processor 201 may send to the computing device a hyperlink to access audio and/or video instruction manual of the selected furniture module.

Furthermore, the computing device 100 may send a third request to modify the layout 400 generated by the server 200. When the user desires to modify the layout 400 displayed on the display 130 of the computing device 100. The processor 110 may provide the user to select one or more furniture modules in the layout 400 and provide an option to move the selected one or more furniture modules to another position within the layout 400. When the computing device 100 is configured to obtain the layout 400 from the server 200, the processor 110 sends the third request which includes identification codes of the selected one or more furniture module and the co-ordinates of the new position within the layout 400. In response to the third request, the processing unit 210 generates a modified layout based on the third request, the initial layout 400, and the predefined rules. The modified layout is transmitted by the processing unit 210 to the computing device 100, which is then displayed to the user of the computing device 100.

Ready-To-Install (RTI) and Ready-To-Assemble (RTA) furniture are packed and shipped in smaller boxes in a ‘knocked-down’ format. In general, a user will have to open up each box and put together all the loose components and hardware by themselves. The RTA and RTI furniture have gained momentum recently, with consumers increasingly inclined towards the DIY (Do-It-Yourself) trend.

RTA/RTI furniture, sold by manufacturer or seller, are provided with installation manuals along with the furniture to guide the customers. The installation manuals include information on the complete list of components and parts with detailed instructions on how to put them all together and install them at the installation site. The installation manual is a physical printed document and would be difficult for user to understand the instructions and identify each and every component among the large shipments.

The present subject matter provides systems and methods to actualize a virtual interactive furniture assembly assistant tool for the users to assemble and install furniture from scratch. The virtual interactive furniture assembly assistant tool may be implemented using the computing device 100, which allows a user to visualize and understand layout of a room, provides visual guidance to identify each component and part of a furniture module, and step-by-step guide to assemble the furniture modules. For example, the user, alternatively referred to as a customer hereinafter, orders for a kitchen space may need one or more furniture modules. The furniture modules may be cabinets, shelves, drawers, organizers, worktops, trolleys, or accessories.

FIG. 4 is an exemplary illustration of the kitchen layout 400 displayed to the user by the computing device 100 of FIG. 1, in accordance with an embodiment of the present disclosure. The kitchen layout 400 may be generated by the computing device 100 or by the server 200. The computing device 100 or the sever 200 may implement the machine learned module(s) to generate the kitchen layout 400 and arrange the furniture modules 305-375 with the layout 400. The generation of the kitchen layout 400 may be based on the dimensions and shape of the kitchen, furniture modules 305-375 purchased by the user, the predefined rules with respect to designing of the kitchen, or user preferences. FIG. 5 is an exemplary illustration of arrangement of furniture modules 305-375 within the layout 400 of FIG. 4, in accordance with the embodiment of the present disclosure. After generating the kitchen layout 400, the computing device 100 or the sever 200 may position the furniture modules 305-375 within the layout, as per the specifications of each of the furniture modules 305-375 and the layout 400. Further, the user may

The kitchen layout 400 may assist the user to visualize a suitable position of each furniture module 305-375 in the kitchen space. The computing device 100 may provide an interactive functionality for the user to select a furniture module displayed in the kitchen layout 400. For example, a kitchen cabinet may be highlighted when the user does a mouseover action or provides a touch/hand gesture at the computing device 100. Thereafter, the computing device 100 may provide detailed information of the selected furniture module. The detailed information may include a link to access visual instruction manuals to install and/or assemble selected furniture module. In some embodiments, the identification code may be provided on a packaging shipped for the selected furniture module. The identification code may be printed on the packaging in the form of a barcode or a QR code. The user may scan the codes from the packaging of the furniture modules using the computing device 100 and may obtained the visual instruction manuals of each of the furniture modules. The virtual interactive furniture assembly assistant tool may reduce the time required to assemble and install furniture modules. When a group of people are building the kitchen, each user in the group of people may utilize corresponding computing device 100 to scan and obtain visual instruction manual for a furniture module.

A manufacturer/seller of the RTA or RTI cabinetry may provide its users a printed Installation Manual which may contain an identification code in form of a QR Code/barcode. The scanning of the code from the installation manual or from the package by the camera of the computing device 100 may invoke the processor 110 to decode and obtain the identification code for a furniture module. Thereafter, the processor 110 directs the user to scan QR code/barcode of subsequent furniture modules.

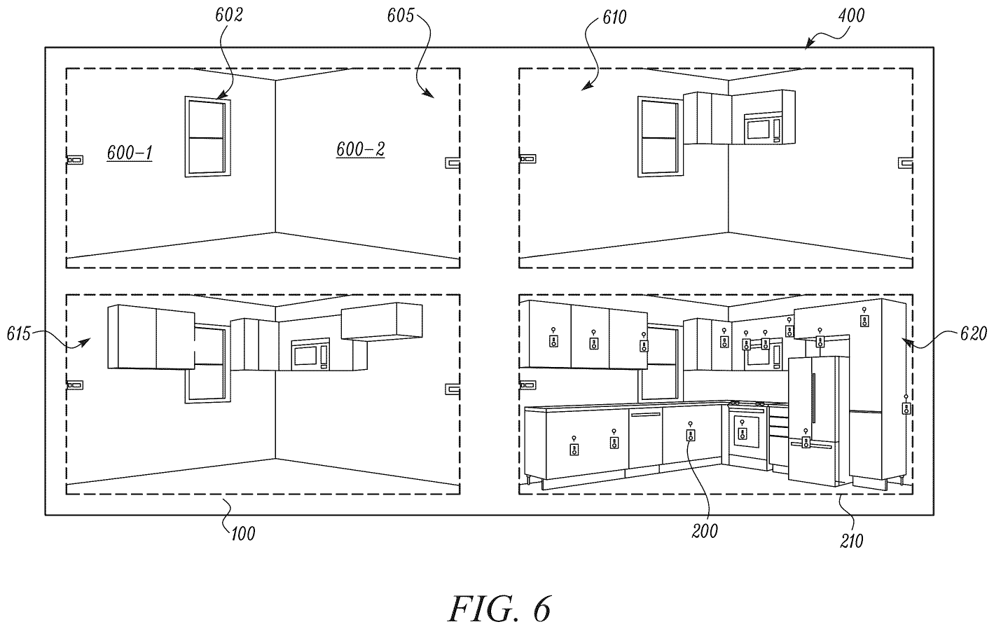

In some embodiments, a part or a component of a furniture module may have a corresponding identification code. When the processor 110 may determines that the identification codes corresponds to a part or a component of a furniture module, the processor 110 may obtain a visual instruction manual corresponding to the part or the component and may start streaming of corresponding video from a section where the part or the component may have introduced, instated of playing the video from beginning and displaying the entire process in a step-by-step manner. FIG. 6 is an exemplary illustration of different states installing the furniture modules 305-375 in the kitchen 600 with assistance of the computing device 100 of FIG. 1, in accordance with the embodiment of the present disclosure. A first state 605 illustrates a portion of the empty kitchen 600 having a window 602 on a first wall 600-1. A second state 610 illustrates a first furniture module assembled and installed at a second wall 600-2 of the kitchen 600 by the user with assistance and guidance received from the computing device 100. A third state 615 illustrates two additional furniture modules assembled and installed by the user on the first wall 600-1 and the second wall 600-2, respectively. A fourth state 620 illustrates the kitchen 600 installed with the all the furniture modules 305-375.

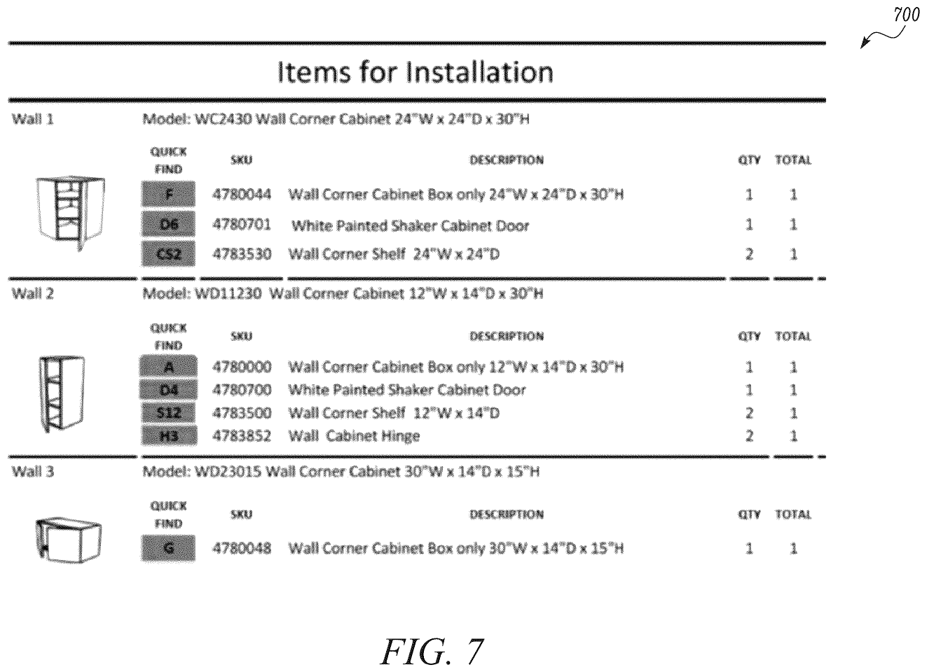

FIG. 7 is an exemplary illustration of displaying information of the furniture modules by the computing device of FIG. 1, in accordance with the embodiment of the present disclosure. The computing device 100 may display a list 700 of furniture modules after obtaining the identification codes from the scanned QR codes or the barcodes. As shown in FIG. 7, the list 700 includes information about each of the furniture modules like model name, description (part/component name and dimensions), quantity, stock keeping unit (SKU) number, etc.

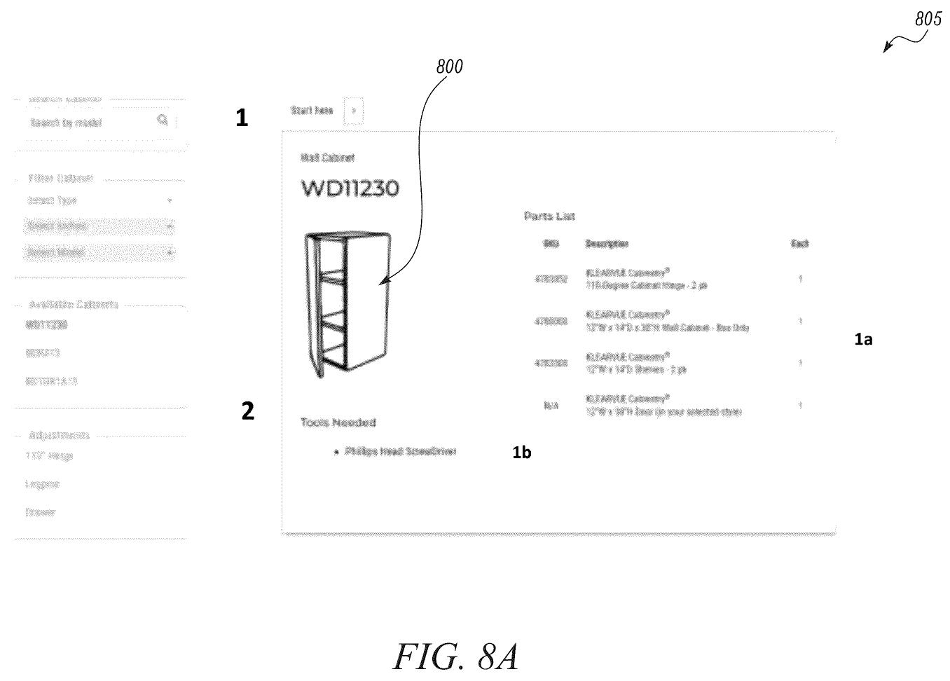

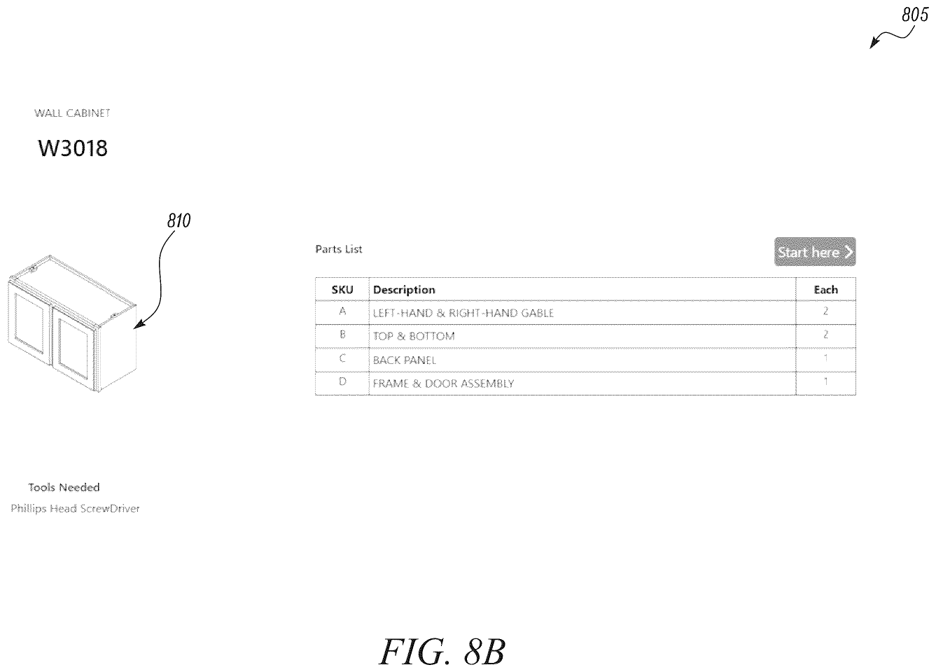

FIG. 8A is an exemplary illustration of displaying details about the components of a first type of wall cabinet 800 by the computing device of FIG. 1, in accordance with the embodiment of the present disclosure. FIG. 8B is an exemplary illustration of displaying details about the components of a second type of wall cabinet 810 by the computing device of FIG. 1, in accordance with the embodiment of the present disclosure. When the user selects a furniture module from the layout 400 or from the list 700 of furniture module. The list allows the user to navigate through the entire furniture modules 305-375 with one cabinet at a time. The computing device 100 may obtain and display the details about the components and/or parts required to assemble the selected furniture module. In example implementation, the computing device 100 provides an interface 805 for the user to search for a specific furniture module. Accordingly, the user can enter a model number marked on the packaging of a furniture module to jump directly to that portion of a portion of video describing assembling/installation of the furniture module.

The computing device 100 may obtain the detailed information about the furniture modules from the server 200. The server 200 is configured to receive one or more request from the computing device 100. Based on the one or more requests, the server 200 retrieves furniture information from the database 225 and sends the furniture information to the computing device 100.

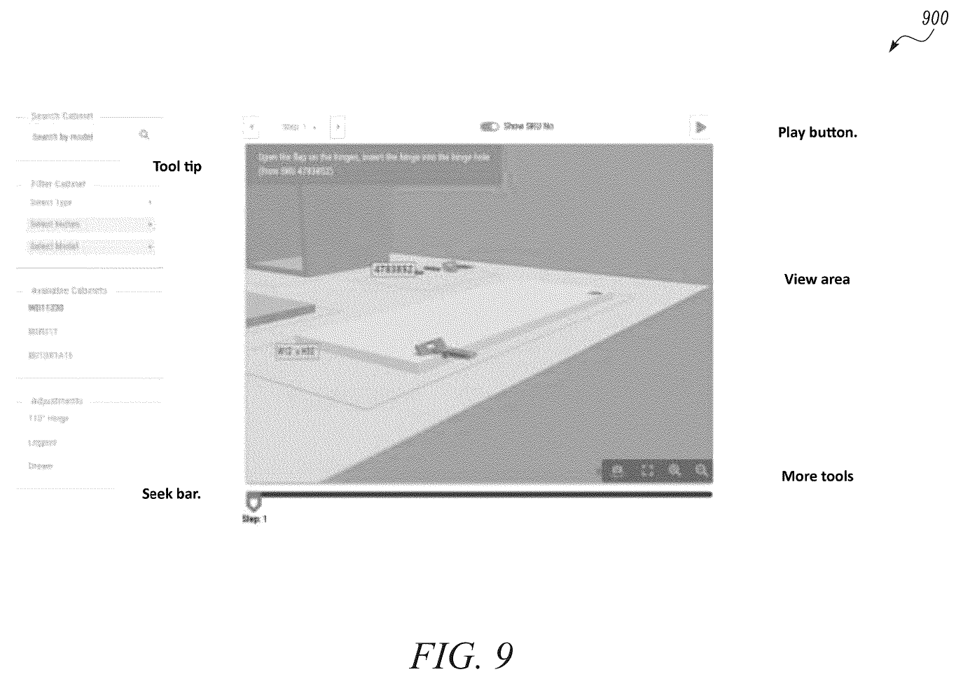

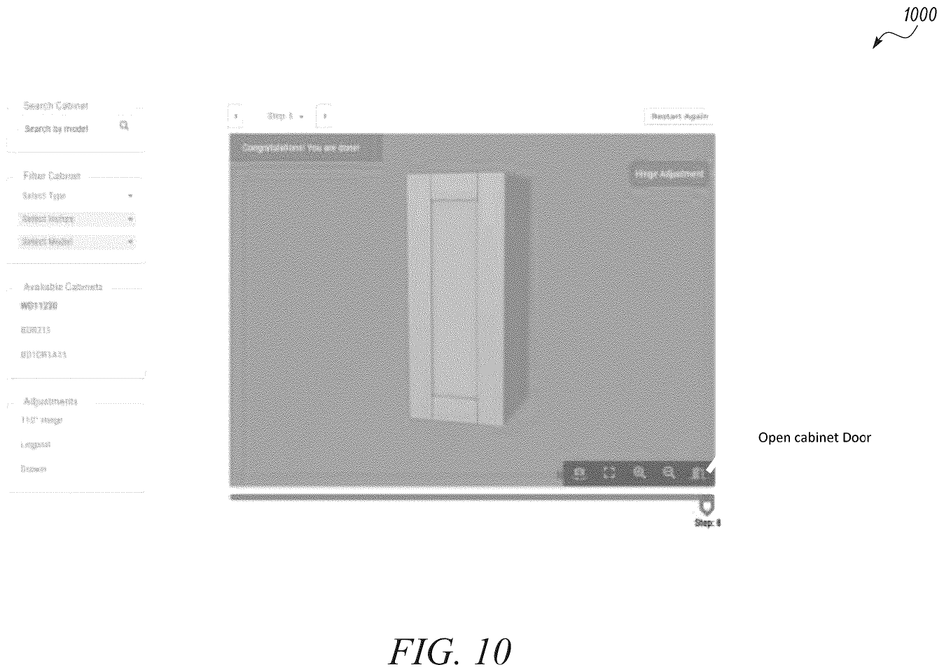

FIG. 9 and FIG. 10 are exemplary illustrations of an intermediate step 900 and a last step 1000 of assembling and installing the first type of wall cabinet 800 (as shown in FIG. 8A), in accordance with the embodiment of the present disclosure. Referring to FIG. 9, an interactive video for assembling and installing the wall cabinet 800 provides a step-by-step guide to the user. The video may be displayed by the computing device 100 and allows the user to pause, play, forward, review the video interactively. The computing device 100 may provide interactive assistance for assembling and installing the furniture modules. For interactive assistance, the computing device 100 provides and displays 1. Tool tip to indicate necessary tools required for completing an assembling step throughout the installation and assembling process, 2. The Play button and Seek bar for streaming assembling tutorial in automated mode or in manual mode or toggle between the two modes, 3. A viewing area for displaying the tutorials and instructions for helping the users to with the installation/assembling process, and 4. More tools like, but not limited to, a camera icon to change the angle of view, a viewfinder icon to switch between full screen and minimized screen view, and c. a zoom in and out icon to enlarge and minimize the view.

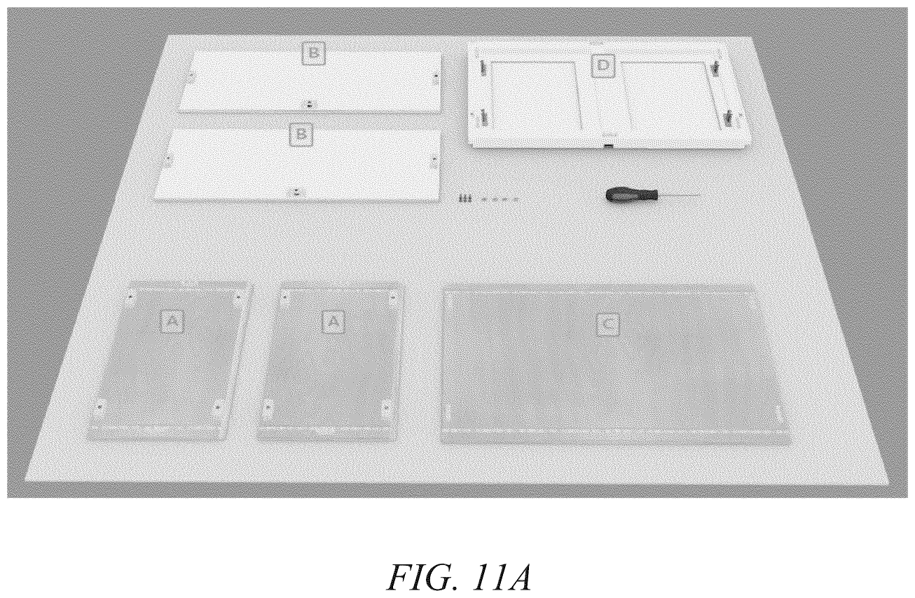

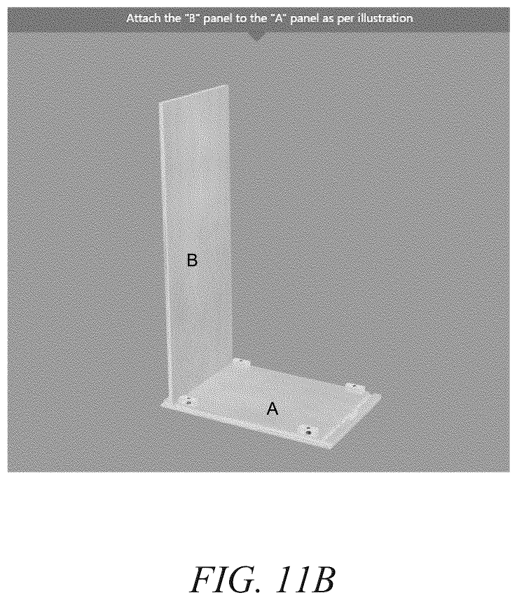

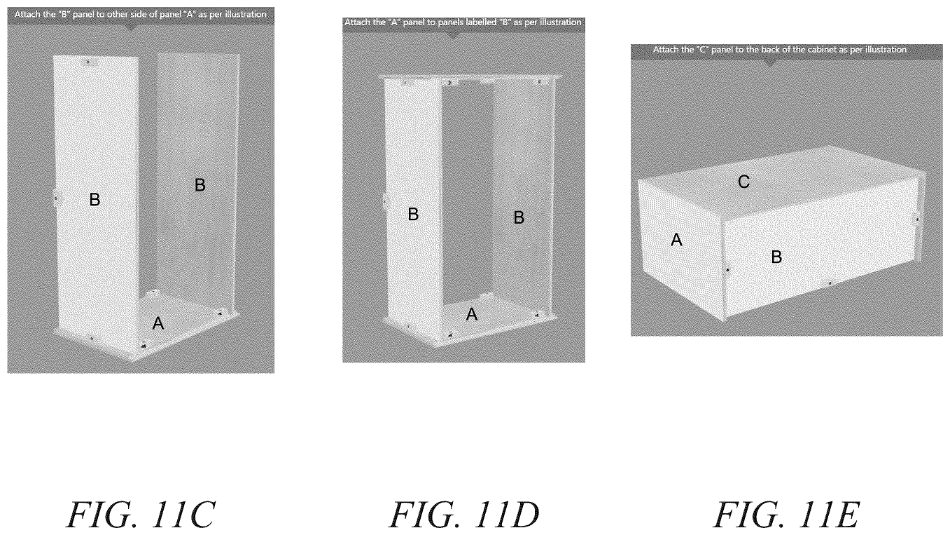

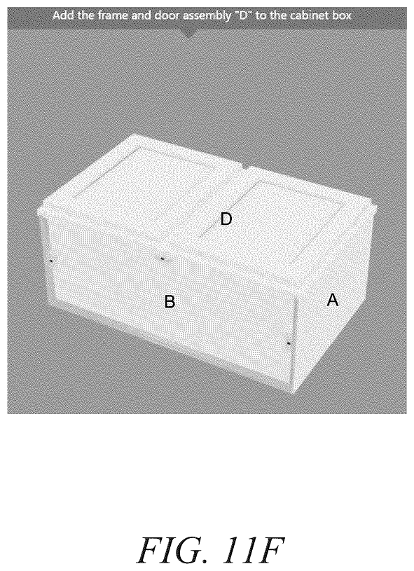

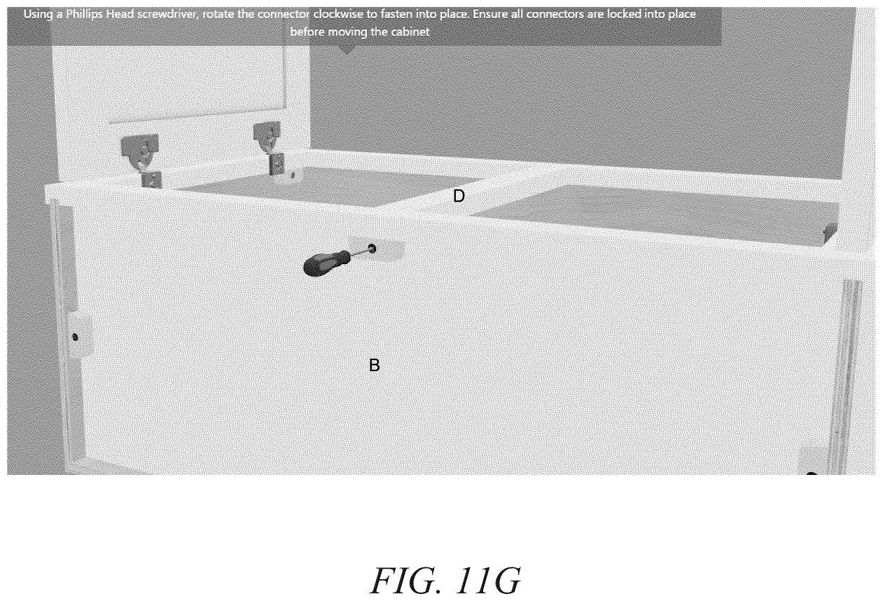

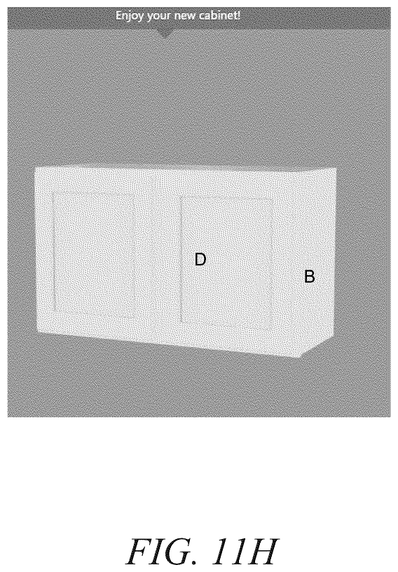

FIG. 11A to FIG. 11H are exemplary illustrations of step-by-step guide to assemble and install the second type of wall cabinet module 810 of FIG. 8B, in accordance with the embodiment of the present disclosure. With reference to FIGS. 11A to 11H, it may be apparent that the wall cabinet 810 may be assembled in multiple steps. The computing device 100 may provide the flexibility to the user to select any step of the assembly and view the actions to be performed in each step repeatedly if needed. Further, in each step of FIG. 11A to FIG. 11H, the computing device 100 may provide different 3D views and/or animations of the components to be assembled, and subsequent assembly of the components may be provided. Moreover, the 3D views and/or animations at different angles of view from the perspective of the user and/or based on the Cartesian co-ordinates may also be provided. For example, referring to FIG. 11A, the computing device 100 may display a first animated view of components of the second type of wall cabinet module 810, like, cabinet panels (A, B, and C), frame with door assembly (D), screws, and a tool required to assemble the second type of wall cabinet module 810, for example, a screwdriver. Referring to FIG. 11B, the computing device 100 may display a second animated view of a first cabinet plank A to be placed adjacent to a second cabinet plank B at a specific location and at a specific angle to the first cabinet plank B. Similarly, FIGS. 11C to 11E illustrate different views indicating placement of remaining cabinet planks displayed by the computing device 100. FIG. 11F illustrates a view indicating placement of frame and door assembly D over the panels (A and B) and FIG. 11G illustrates another view indicating locations for fastening a screw to secure the frame D with the panel B. FIG. 11H illustrates an assembled view of the second type of wall cabinet module 810. Thus, the animated views in each step may dynamically change, for example, the assembled components may be shown rotating at relevant angles to provide focus on the next component(s) and/or set of components to be assembled. In some embodiments, the computing device 100 may also provide an option to the user to modify the assembly components, component locations, and/or instructions to build the cabinet per the user's requirements.

The computing device 100 provides step-by-step guided video tutorials showing how each part/component need to be assembled/installed. The user may get customization and personalization of the design and layout of the installation unit. Further, the computing device 100 provides features such as DIY (Do it Yourself), and AR (Augmented Reality) to visualize the final output of your space, and adjustments where user can take a very closer look at the specific step.

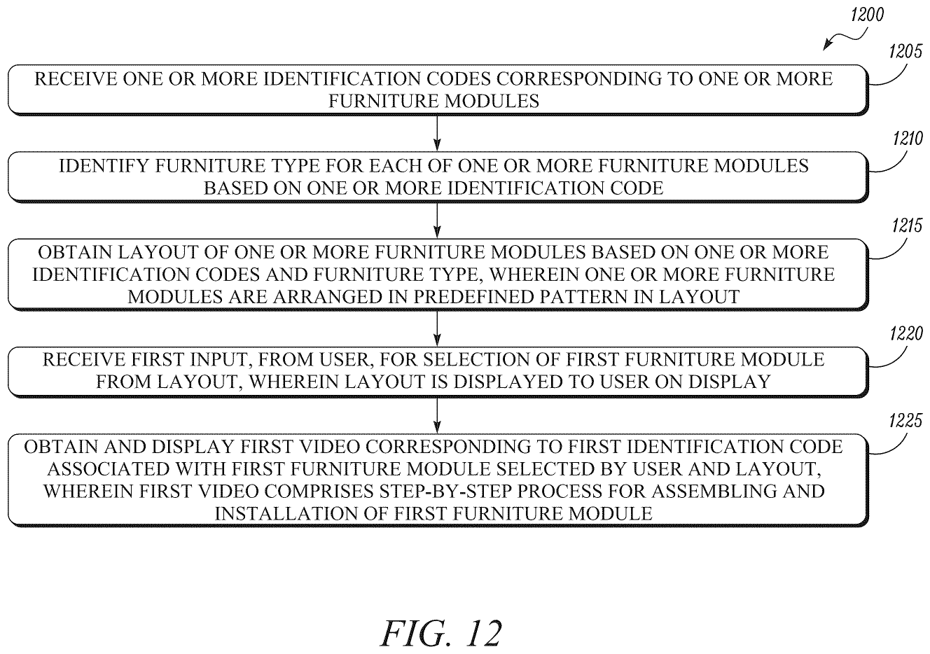

FIG. 12 is an exemplary method 1200 for assisting the user to assemble one or more furniture modules in the room, implemented by the computing device of FIG. 1, in accordance with the embodiment of the present disclosure. At step 1205, one or more identification codes corresponding to the one or more furniture modules are received by the computing device 100. At step 1210, a furniture type for each of the one or more furniture modules based on the one or more identification codes is identified by the computing device 100. At step 1215, a layout of the one or more furniture modules is obtained by the computing device 100. The layout is based on the one or more identification codes and the furniture type, and the one or more furniture modules are arranged in a predefined pattern in the layout. In an example implementation, the layout may be the kitchen layout 400. At step 1220, a first input is received by the computing device 100 from the user. The first input is for selection of a first furniture module from the layout, wherein the layout is displayed to the user on a display. At step 1225, a first video corresponding to a first identification code associated with the first furniture module selected by the user and the layout is obtained and displayed by the computing device 100. The first video comprises a step-by-step process for assembling and installation of the first furniture module.

Steps 1220 and 1225 may be repeated for assembling and installing the remaining furniture modules. For example, a second input from the user for selection of a second furniture module of the one or more furniture module may be received by the computing device 100. Thereafter, a second video based on a second identification code associated with the second furniture module selected by the user is obtained and displayed by the computing device 100. The second video comprises a step-by-step process for assembling and installation of the second furniture module.

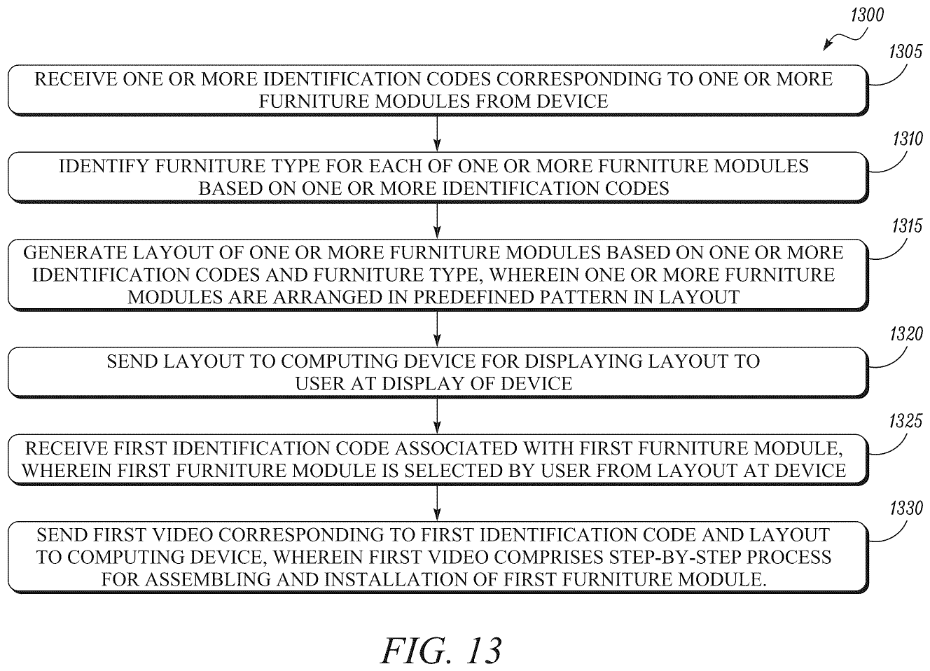

FIG. 13 is an exemplary method for assisting the user to assemble one or more furniture modules in the room, implemented by the server of FIG. 2. At step 1305, one or more identification codes corresponding to the one or more furniture modules are received by the server 200 from the computing device 100. At step 1310, a furniture type for each of the one or more furniture modules based on the one or more identification codes is identified by the server 200. At step 1315, a layout of the one or more furniture modules is generated by the server 200. The layout is based on the one or more identification codes and the furniture type. The one or more furniture modules are arranged in a predefined pattern in the layout. At step 1320, the layout is sent to computing device 100 by the server 200 for displaying the layout to the user at the display 130 of the computing device 100. At step 1325, the first identification code associated with the first furniture module is sent to the computing device 100 by the server 200. At step 1330, the first video corresponding to the first identification code and the layout is sent to the computing device 100 by the server 200.

In the preceding specification, the present disclosure and its advantages have been described with reference to specific embodiments. However, it will be apparent to a person of ordinary skill in the art that various modifications and changes can be made, without departing from the scope of the present disclosure, as set forth in the claims below. Accordingly, the specification and figures are to be regarded as illustrative examples of the present disclosure, rather than in restrictive sense. All such possible modifications are intended to be included within the scope of present disclosure.

What is claimed is:

1. A method for assisting a user to assemble one or more furniture modules in a room, the method is implemented by a computing device comprising a processor and a memory, the method comprising:
receiving one or more identification codes corresponding to the one or more furniture modules;
identifying a furniture type for each of the one or more furniture modules based on the one or more identification codes;
obtaining a layout of the one or more furniture modules based on the one or more identification codes and the furniture type, wherein the one or more furniture modules are arranged in a predefined pattern in the layout;
receiving a first input, from the user, for selection of a first furniture module from the layout, wherein the layout is displayed to the user on a display; and
obtaining and displaying a first video corresponding to a first identification code associated with the first furniture module selected by the user and the layout, wherein the first video comprises a step-by-step process for assembling and installation of the first furniture module.

2. The method as claimed in claim 1, wherein the method comprises:
receiving a second input from the user for selection of a second furniture module of the one or more furniture module; and
obtaining and displaying a second video based on a second identification code associated with the second furniture module selected by the user, wherein the second video comprises a step-by-step process for assembling and installation of the second furniture module.

3. The method as claimed in claim 1, wherein the method comprises:
receiving at least a third input from the user for re-arrangement of the one or more furniture modules within the layout; and
obtaining and displaying, on the display, a revised layout corresponding to the at least third input.

4. The method as claimed in claim 1, wherein the layout comprises the one or more furniture modules arranged according to at least one of predefined rules, user preferences, and room structure.

5. The method as claimed in claim 1, wherein the one or more identification codes are one of a barcode and a quick-response (QR) code.

6. The method as claimed in claim 5, wherein the one or more identification codes are obtained by scanning the barcode or the QR code printed on packages of the one or more furniture modules.

7. A method for assisting a user to assemble one or more furniture modules in a room, the method is implemented by a server comprising a processor and a memory, the method comprising:
receiving one or more identification codes corresponding to the one or more furniture modules from a computing device;
identifying a furniture type for each of the one or more furniture modules based on the one or more identification codes;
generating a layout of the one or more furniture modules based on the one or more identification codes and the furniture type, wherein the one or more furniture modules are arranged in a predefined pattern in the layout;
sending, to the computing device, the layout for displaying the layout to the user at a display of the computing device;
receiving, from the computing device, a first identification code associated with a first furniture module, wherein the first furniture module is selected by the user from the layout at the computing device; and
sending, to the computing device, a first video corresponding to the first identification code and the layout, wherein the first video comprises a step-by-step process for assembling and installation of the first furniture module.

8. The method as claimed in claim 7, wherein the method comprises:
receiving, from the computing device, a second identification code associated with a second furniture module, wherein the second furniture module is selected by the user from the layout; and
sending a second video based on the second identification code to the computing device and the layout, wherein the second video comprises a step-by-step process for the assembling and installation of the second furniture module.

9. The method as claimed in claim 7, wherein the method comprises:
receiving, from the computing device, a request for re-arrangement of the one or more furniture modules within the layout, wherein the computing device received one or more inputs from the user for re-arrangement of the one or more furniture modules displayed in the layout; and
generating and sending, to the computing device, a revised layout corresponding to the re-arrangement request.

10. The method as claimed in claim 7, wherein the layout comprises the one or more furniture modules arranged according to at least one of predefined rules, user preferences, and room structure.

11. A computing device for assisting a user to assemble one or more furniture modules in a room, the computing device comprising:
a memory;
a display;
a processor coupled to the memory and the display, wherein the processor is configured to:
receive one or more identification codes corresponding to the one or more furniture modules;
identify a furniture type for each of the one or more furniture modules based on the one or more identification codes;
obtain a layout of the one or more furniture modules based on the one or more identification codes and the furniture type, wherein the one or more furniture modules are arranged in a predefined pattern in the layout;
display the layout to the user on the display;
receive a first input, from the user, for selection of a first furniture module from the layout; and
obtain and display a first video corresponding to a first identification code associated with the first furniture module selected by the user and the layout wherein the first video comprises a step-by-step process for the assembling and installation of the first furniture module.

12. The computing device as claimed in claim 11, wherein the processor is configured to:
receive a second input from the user for selection of a second furniture module of the one or more furniture module; and
display a second video based on a second identification code associated with the second furniture module selected by the user and the layout, wherein the second video comprises a step-by-step process for the assembling and installation of the second furniture module.

13. The computing device as claimed in claim 11, wherein the processor is configured to:
receive at least a third input from the user for re-arrangement of the one or more furniture modules within the layout; and
obtain and display, on the display, a revised layout corresponding to the third input.

14. The computing device as claimed in claim 11, wherein layout comprises the one or more furniture modules arranged according to at least one of predefined rules, user preferences, and room structure.

15. The computing device as claimed in claim 11, wherein the one or more identification codes are one of barcode and quick-response (QR) code.

16. The computing device as claimed in claim 15, wherein the computing device comprises a camera module for scanning images of barcodes or the QR codes printed on packages of the one or more furniture modules, and wherein the processor is configured to obtain the one or more identification codes by decoding the scanned images.

17. A server for assisting a user to assemble one or more furniture modules in a room, the server comprising:
a memory;
a processor coupled to the memory, wherein the processor is configured to:
receive one or more identification codes corresponding to the one or more furniture modules from a computing device;
identify a furniture type for each of the one or more furniture modules based on the one or more identification codes;
generate a layout of the one or more furniture modules based on the one or more identification codes and the furniture type, wherein the one or more furniture modules are arranged in a predefined pattern in the layout;
send, to the computing device, the layout for displaying the layout to the user at a display of the computing device;
receive, from the computing device, a first identification code associated with a first furniture module, wherein the first furniture module is selected by the user from the layout at the computing device; and
send, to the computing device, a first video corresponding to the first identification code and the layout, wherein the first video comprises a step-by-step process for the assembling and installation of the first furniture module.

18. The server as claimed in claim 17, wherein the processor is configured to:
receive, from the computing device, a second identification code associated with a second furniture module, wherein the second furniture module is selected by the user from the layout; and
sending a second video based on the second identification code to the computing device and the layout, wherein the second video comprises a step-by-step process for the assembling and installation of the second furniture module.

19. The server as claimed in claim 17, wherein the processor is configured to:
receive, from the computing device, a request for re-arrangement of the one or more furniture modules within the layout, wherein the computing device received one or more inputs from the user for re-arrangement of the one or more furniture modules displayed in the layout; and
generate and send, to the computing device, a revised layout corresponding to the third input.

20. The server as claimed in claim 17, wherein the layout comprises the one or more furniture modules arranged according to at least one of predefined rules, user preferences, and room structure.
